(19) United States
(12) Patent Application Publication
(10) Pub. No.: US 2012/0231128 A1
(43) Pub. Date: Sep. 13, 2012

(54) FRUIT/VEGETABLE WITH ADDITIVE TO PREVENT DISCOLORATION

(75) Inventors: Richard Schlomer Meyer, Kent, WA (US); Jonathan A. Merkle, Cologne, MN (US)

(73) Assignee: MICHAEL FOODS, INC., Minnetonka, MN (US)

(21) Appl. No.: 13/413,957

(22) Filed: Mar. 7, 2012

Related U.S. Application Data
(60) Provisional application No. 61/449,886, filed on Mar. 7, 2011.

(51) Int. Cl. A23L 1/272; A23L 1/216; A23B 7/10

(52) U.S. Cl. 426/268; 426/615; 426/637

(57) ABSTRACT

A fruit or vegetable, such as a pome or root vegetable, may be at least partially infiltrated with an additive to help prevent discoloration of the fruit or vegetable. In some examples, the additive helps the fruit or vegetable retain its natural color upon being exposed to air. In some examples, the additive includes gluconic acid. By maintaining the color of the fruit or vegetable, the shelf life and salability of the fruit or vegetable may be increased as compared to an untreated fruit or vegetable.

This application claims the benefit of U.S. Provisional Patent Application No. 61/449,886, filed Mar. 7, 2011, the entire contents of which are incorporated herein by reference.

### TECHNICAL FIELD

This disclosure relates to fruits and vegetables that have an additive that helps the fruits and vegetables prevent discoloration.

### BACKGROUND

Commercially processed foods have found widespread acceptance among the consuming public. These commercially processed foods include meats, fruits, vegetables, and nuts, to name a few example categories. The foods can be processed for a variety of different purposes. For example, the foods can be processed to increase shelf life, reduce the likelihood of bacterial growth, make the foods faster and easier to prepare by an end consumer, and even to increase the flavor and/or texture of the foods.

Commercial food processing techniques generally involve some form of washing, cutting, cooking, and/or packaging of a food. For example, consumer demands for quick and easy-to-prepare foods have led to growth in the market for precooked and precut foods. In order to prepare these types of precooked and precut foods, the foods are usually washed and then cooked in an oven, kettle, or other cooking device. Depending on the type of food being prepared, the food may be cut either prior to or after cooking.

Many foods, especially fruits and vegetables, begin oxidizing when the foods are exposed to air during processing. The oxidation process can continue even after the foods are cooked, cut, and/or packaged for resale. As a result, the shelf life of a pre-prepared food may be dictated, at least in part, by the rate at which the food oxidizes. Moreover, many foods, such as fruits and vegetables, change color as the foods oxidize. Because customers typically purchase foods based on physical appearance, among other considerations, the extent to which a food changes color can affect the salability of the food.

### SUMMARY

In general, this disclosure is directed toward food items such as fruits and vegetables that have an additive that helps prevent discoloration of the food items. Reducing or eliminating discoloration of fruits and vegetables may be useful in that if such fruits and vegetables significantly change color (e.g., after being cut and/or cooked), a consumer may be unwilling to purchase the food item.

In one example according to the disclosure, a food product is described that includes fruits or vegetables at least partially infiltrated with an additive that includes gluconic acid. The gluconic acid may function to help prevent discoloration of the fruits or vegetables. Example fruits and vegetables include root vegetables (potatoes, carrots, beets, etc.), pomes from the Maloideae subfamily of the Rosaceae family (apples, pears, quince, loquat, etc.), and the like. In some examples, the additive includes between 0.005 wt % and 10 wt % gluconic acid and the food product is a vegetable such as a potato.

In another example, a method is described that includes placing a firm and crisp fruit or vegetable in a water solution that includes at least one additive that functions to help prevent discoloration of the fruit or vegetable. In some examples, the at least one additive includes gluconic acid. For instance, in one example, the water solution includes between 0.005 wt % and 10 wt % gluconic acid.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual drawing of an example fruit or vegetable.

FIG. 2 is a flow diagram illustrating an example technique for processing a fruit or vegetable in a manner that helps prevent discoloration of the fruit or vegetable.

### DETAILED DESCRIPTION

In general, this disclosure relates to fruits and vegetables that are treated with an additive to help reduce or eliminate discoloration of such fruits and vegetables, e.g., due to exposure to air and/or processing. Discoloration can include graying, browning, or other changes in color that are visually observable to the unaided (e.g., without a microscope) eye. In some examples, the additive helps prevent discoloration of a fruit or vegetable during and/or after cooking. By reducing or eliminating discoloration as compared to an untreated fruit or vegetable, the food item can remain in saleable condition for a longer period of time. By contrast, after a fruit or vegetable becomes discolored, the fruit or vegetable is generally considered unsalable and is removed from a retail shelf (i.e., in examples where the fruit or vegetable is sold in a retail setting).

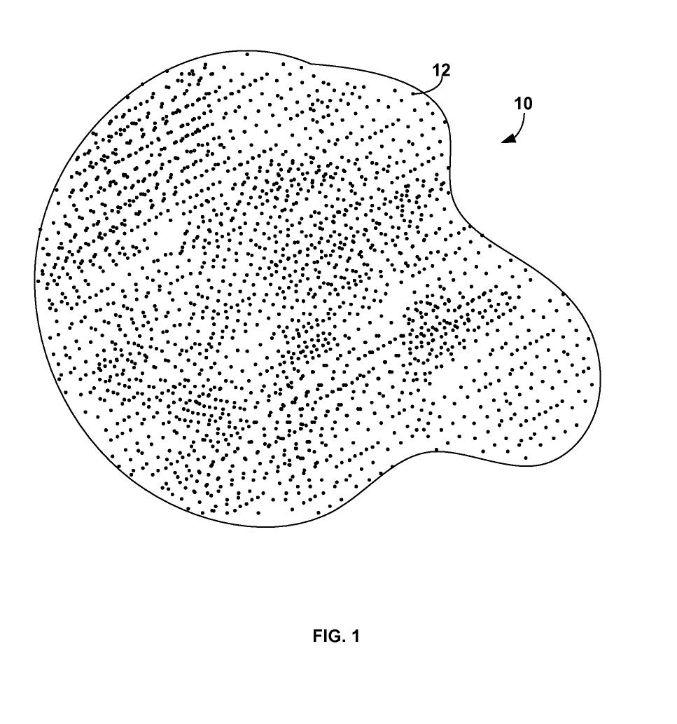

FIG. 1 is a conceptual illustration of an exemplary fruit or vegetable 10. By way of example, fruit or vegetable 10 may be a root vegetable (e.g., potato, carrot, beet, turnip), a pome (e.g., apple, pear, quince, loquat), or a combination of fruits and/or vegetables. Other fruits and vegetables that may benefit from treatment with an additive include, but are not limited to, cucumbers, melons and squash. In some examples, fruit or vegetable 10 is a fruit or vegetable that exhibits a firm and crisp texture.

Independent of the specific type of fruit and/or vegetable, the fruit or vegetable 10 of the present invention may includes pores 12. Pores 12 are channels, cavities, or passages that extend from the exterior surface of the fruit or vegetable 10 toward the interior of the fruit or vegetable 10. Pores 12 may allow ingress and egress of flowable liquids and gases to the fruit or vegetable 10.

During processing, the firm and crisp fruit or vegetable 10 may be cut, cooked, or otherwise prepared for consumption and/or sale. For example, the fruit or vegetable 10 may be cooked in an oven, boiled in a kettle, or otherwise heated to cook the food item. This cooking process may begin to break down the cellular structure of the fruit or vegetable 10 and, depending on the type of fruit or vegetable, convert complex carbohydrates to simple sugars.

The fruit or vegetable 10 of the present invention may be exposed to air during these cooking and preparation processes. Depending on the type of fruit or vegetable being processed, the fruits or vegetables 10 may begin to oxidize after being exposed to air. An exterior surface of a firm and crisp fruit or vegetable 10 may change color as it oxidizes. For example, fruit or vegetable 10 may turn brown or gray, with the intensity (e.g., darkness) of the browning or graying increasing the longer the fruits and vegetables are exposed to air. This color change can make such fruits and vegetables 10 visually unappealing.

In accordance with this disclosure, a firm and crisp fruit or vegetable 10 is at least partially infiltrated with an additive that may function to help prevent discoloration of the fruit or vegetable 10. The additive may function to help prevent discoloration of the fruit or vegetable 10 during and/or after cooking. In some examples, the additive includes gluconic acid. By infiltrating the fruit or vegetable 10 with the additive, discoloration of the fruit or vegetable 10 can be reduced or eliminated as compared to an untreated fruit or vegetable, even after it is processed and exposed to air.

In the embodiments of the present invention, a firm and crisp fruit or vegetable 10 includes an additive that functions to help prevent discoloration of the food item. In some examples, the fruit or vegetable 10 may include a plurality of additives (e.g., two, three, four, or more additives) that each individually, or together in combination, function to help prevent discoloration of the fruit or vegetable 10.

In one example, the additive includes (or, optionally, consists essentially of) gluconic acid. A gluconic acid additive can have a concentration that is 100% gluconic acid, or the gluconic acid additive can be diluted to form a gluconic acid solution. In some examples, a gluconic acid additive is a gluconic acid solution that ranges from 10 wt % gluconic acid and 90 wt % water to 90 wt % gluconic acid and 10 wt % water. For instance, in one example, the gluconic acid solution includes approximately 50 wt % gluconic acid and approximately 50 wt % water, although other concentrations of gluconic acid are both contemplated and possible. Further, as will be described in greater detail below, the gluconic acid solution may be added to a separate portion of water (e.g., cooking water) to further dilute the concentration of acid that is used to infiltrate the fruits and vegetables 10.

While different additives in addition to or in lieu of gluconic acid may be used, gluconic acid generally does not affect the taste of the fruits and vegetables 10 (e.g., by changing the flavor of the fruits and vegetables 10 or imparting a metallic flavor). This may be beneficial for modifying the properties of the fruits and vegetables 10 without changing the taste profile of such food items.

Any suitable technique can be used to at least partially infiltrate the fruits and vegetables 10 of the present invention with an additive. In some examples, the fruit or vegetable 10 is at least partially infiltrated with the additive by soaking the fruit or vegetable 10 in a liquid solution that includes the additive. For instance, in one example, the fruit or vegetable 10 is completely submerged in a water solution that includes the additive. The water solution enters pores 12 of the fruit or vegetable 10 and flows toward the interior of the fruit or vegetable 10. In this manner, the fruit or vegetable 10 is at least partially infiltrated with an additive solution. Depending on a variety of factors such as the type of additive solution, the type of infiltration process, and the length of time that fruit or vegetable 10 is infiltrated with additive, the fruit or vegetable 10 may become partially or even completely saturated with additive solution. Accordingly, in some examples, the additive may only partially infiltrate the fruit or vegetable 10 so that the additive is not transported to or present at the center of the fruit or vegetable. In other examples, the additive may fully infiltrate the fruit or vegetable so that the additive is transported to and present throughout the entire structure of the fruit or vegetable.

In examples where the fruit or vegetable 10 is infiltrated by submerging or otherwise contacting it with a water-based additive solution, a suitable amount of additive solution should be added to the fruit or vegetable. The amount of additive solution added to the fruit or vegetable may be based on the weight of the fruit or vegetable. For instance, in one example, at least one weight part of additive solution is added to a container for every weight part of the fruit or vegetable added to the container. In another example, approximately two weight parts of additive solution are added to a container for every weight part of the fruit or vegetable added to the container. Different relative amounts of additive solution and fruit or vegetable are possible and contemplated.

The fruits and vegetables 10 may be processed prior to being infiltrated with the additive solution. Processing prior to infiltration may increase the surface area of the fruits and vegetables 10 and/or remove barriers that limit infusion. For instance, when fruit or vegetable 10 is a potato, carrot, apple or similar fruit or vegetable, the skin of the fruit or vegetable can inhibit transport of additive solution into the flesh of the fruit or vegetable. For this reason, the fruit or vegetable 10 is peeled in some examples prior to being infiltrated with additive solution. In some additional examples, the fruit or vegetable 10 is cut (e.g., diced, shredded, chopped, or the like) to increase the surface area of the fruit or vegetable exposed to additive solution. Increased surface area can increase the amount of additive solution that enters the fruit or vegetable and/or decrease the amount of time that the fruit or vegetable needs to be exposed to the additive solution. Additional or different pre-infiltration processing steps are possible.

In some examples, fruit or vegetable 10 is cooked (e.g., heated) while being infiltrated with an additive solution. For example, fruit or vegetable 10 may be boiled in a water-based solution that includes the additive. Heating the additive solution can cook the fruit or vegetable 10 (e.g., partially or fully) and/or increase the diffusion of the additive solution into the pores of the fruit or vegetable. In examples where the fruit or vegetable 10 is boiled in a water-based additive solution, the fruit or vegetable can be boiled for any suitable amount of time. For instance, in some examples, the fruit or vegetable 10 is boiled in a water-based additive solution for greater than 5 minutes (e.g., from approximately 10 to approximately 35 minutes).

In other examples, fruit or vegetable 10 is cooked prior to being infiltrated with additive solution. For example, the fruit or vegetable 10 may be partially cooked to open pores 12 of the fruit or vegetable 10. Thereafter, the fruit or vegetable 10 may be infiltrated with an additive solution and then further cooked to complete the cooking process. In other examples, an uncooked fruit or vegetable is placed in an additive solution that remains at a substantially ambient temperature.

The additive solution used in the present invention can have a variety of different concentrations. In one example, fruit or vegetable 10 is infiltrated with an additive solution that includes (or, optionally, consists essentially of) between 0.0001 wt % and 10 wt % additive such as, e.g., 0.0001 wt % and 5 wt % or between 0.1 wt % and 3 wt % additive, or between 0.25 wt % and 0.65 wt % additive. In one specific example, fruit or vegetable 10 is infiltrated with an additive solution that includes approximately 0.5 wt % additive. The remaining weight portion of each of the foregoing additive solutions may include or be made up of water. For instance, in the example of an additive solution that includes (or, optionally, consists essentially of) approximately 5 wt % additive, the solution may further include approximately 95 wt % water.

In another example, fruit or vegetable 10 is infiltrated with an additive solution that includes (or, optionally, consists essentially of) between 0.0001 vol % and 5 vol % additive such as, e.g., between 0.05 vol % and 5 vol %, or between 0.1 vol % and 3 vol % additive, or between 0.25 vol % and 0.65 vol % additive. In one specific example, a fruit or vegetable 10 is infiltrated with an additive solution that includes approximately 0.5 vol % additive. The remaining volume of each of the foregoing additive solutions may include or be made up of water. For instance, in the example of an additive solution that includes (or, optionally, consists essentially of) approximately 5 vol % additive, the solution may further include 95 vol % water. The foregoing descriptions of additives and additive solutions are merely examples, however, and it should be appreciated that the disclosure is not limited in this respect.

As will be appreciated by those of ordinary skill in the art, the amount of additive that is added to water (e.g., cooking water) to achieve a desired solution concentration will vary based on the concentration of the additive. For instance, when the additive includes a gluconic acid solution that includes approximately 50 wt % gluconic acid and approximately 50 wt % water, approximately twice as much gluconic acid solution will need to be added to a base amount of water as a 100 wt % gluconic acid additive to achieve the same final concentration.

As noted above, treating fruits and vegetables with an additive in accordance with this disclosure can help prevent the fruits and vegetables from discoloring. In some examples, a fruit or vegetable treated with an additive solution according to the disclosure exhibits no color change after being exposed to air for a period of time and maintains substantially the same color as the untreated fruit or vegetable exhibits immediately after being exposed to air (e.g., the natural color immediately after being peeled, cut, taken out of water, or the like).

When fruit or vegetable 10 is at least partially infiltrated with an additive according to the disclosure, the fruit or vegetable may exhibit less change in color upon being exposed to air than a comparable fruit or vegetable that is not at least partially infiltrated with an additive. This may increase the aesthetic appeal of the fruit or vegetable to consumers and, correspondingly, increase the shelf life of the fruit or vegetable.

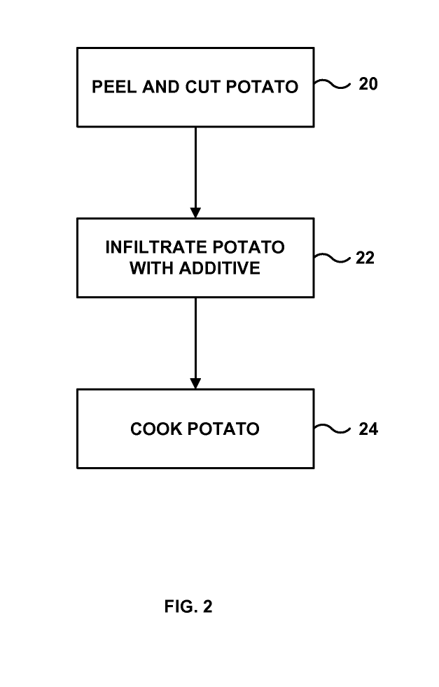

A variety of different techniques may be used to process fruits and vegetables according to the present disclosure. FIG. 2 is a flow diagram illustrating an example technique for processing a fruit or vegetable in a manner that helps the fruit or vegetable retain its natural color during and/or after being exposed to air. For ease of description, the technique of FIG. 2 is described with regard to a fruit or vegetable 10 that is a potato. However, different types of fruits and vegetables may be used according to the disclosure, and it should be appreciated that the disclosure is not limited in this respect.

According to the example technique of FIG. 2, potato 10 is peeled and optionally cut (20). Peeling removes the skin of potato 10, which can act as a barrier that limits the transport of additive solution into the flesh of the potato. Cutting potato 10 increases the surface area of the potato, which can increase the amount of additive solution that enters the potato and/or decrease the amount of time that the potato needs to be exposed to the additive solution. In different examples, the raw potato 10 is cut by dicing, shredding, or slicing the potato. In some examples, potato 10 is peeled and cut (20) while preparing a precooked and precut potato product that is intended for resale. Once peeled, the potato is exposed to air, which can trigger oxidation that can change the color of the potato.

After peeling and optionally cutting potato 10 (20), potato 10 is at least partially infiltrated with an additive that functions to help retain the color of potato 10 upon cooking. In some examples, potato 10 is fully infiltrated (e.g., saturated) with the additive. In some examples, potato 10 is infiltrated by submerging the potato in a water-based solution that includes the additive.

The additive includes one or more additives that function to help prevent discoloration of potato 10 upon being exposed to air. In one example, the additive is gluconic acid. For example, a dilute gluconic acid that includes approximately 50 wt % gluconic acid and approximately 50 wt % water may be added to cooking water to achieve a gluconic acid concentration between 0.05% and 10% gluconic acid such as, e.g., a gluconic acid concentration between 0.1% and 3% gluconic acid.

The technique of FIG. 2 includes cooking potato 10 (24). In different examples, potato 10 is cooked (24) before being infiltrated with the additive (22), after being infiltrated with the additive (22), or while being infiltrated with the additive (22). For instance, potato 10 may be cooked while being infiltrated with the additive by submerging potato 10 in a heated (e.g., boiling) solution that includes the additive. In some examples, potato 10 is partially cooked (24). In other examples, potato 10 is fully cooked (24). In some examples, potato 10 is boiled in a gluconic acid solution for at least 3 minutes; in other examples at least 5 minutes. It is beneficial in a number of embodiments that the fruit or vegetable is exposed long enough to the additive so that the additive penetrates all the way to the center of the fruit or vegetable (e.g., fully infiltrates the fruit or vegetable).

After cooking (24), potato 10 may be removed from the water solution and again exposed to air. Potato 10 may exhibit little or no color change upon being exposed to the air, at least as compared to a potato that is not at least partially infiltrated with an additive. In some examples, potato 10 exhibits substantially no graying, browning, or other visually observable changes in color (e.g., to the unaided eye) after being exposed to air for greater than 1 day such as, e.g., greater than 3 days, or greater than 5 days.

Various examples have been described. These and other examples are within the scope of the following claims.

1. A food product comprising:
a fruit or vegetable at least partially infiltrated with an additive that includes gluconic acid.

2. The food product of claim 1, wherein the additive includes between 0.005 wt % and 10 wt % gluconic acid and a balance weight percentage that comprises water.

3. The food product of claim 2, wherein the additive includes between 0.1 wt % and 3 wt % gluconic acid.

4. The food product of claim 2, wherein the additive includes between 0.25 wt % and 0.65 wt % gluconic acid.

5. The food product of claim 1, wherein the additive consists essentially of gluconic acid.

6. The food product of claim 2, wherein the fruit or vegetable is a root vegetable or a pome.

7. The food product of claim 6, wherein the fruit or vegetable is a potato.

8. The food product of claim 7, wherein the potato is a peeled potato.

9. The food product of claim 8, wherein the peeled potato is cut into pieces.

10. The food product of claim 1, wherein the fruit or vegetable includes external pores and the external pores are at least partially saturated with the additive.

11. The food product of claim 10, wherein the fruit or vegetable is saturated with the additive.

12. The food product of claim 1, wherein the fruit or vegetable is cooked.

13. A method comprising:
placing a fruit or vegetable in a water solution that includes at least one additive that functions to help prevent discoloration of the food item, wherein the at least one additive includes gluconic acid.

14. The method of claim 13, wherein the water solution includes between 0.005 wt % and 10 wt % gluconic acid.

15. The method of claim 14, wherein the water solution includes between 0.1 wt % and 3 wt % gluconic acid.

16. The method of claim 15, wherein the water solution includes between 0.25 wt % and 0.65 wt % gluconic acid.

17. The method of claim 13, wherein the additive consists essentially of the gluconic acid.

18. The method of claim 13, wherein placing the fruit or vegetable in the water solution comprises placing less than approximately 1 weight part of the fruit or vegetable for every 1 weight part of water solution.

19. The method of claim 13, further comprising cooking the fruit or vegetable.

20. The method of claim 19, wherein cooking the fruit or vegetable comprises cooking the fruit or vegetable in the water solution.

21. The method of claim 20, wherein cooking the fruit or vegetable in the water solution comprises cooking the fruit or vegetable in the water solution for at least five minutes.

22. The method of claim 13, wherein the fruit or vegetable is a root vegetable or pome.

23. The method of claim 22, wherein the fruit or vegetable is a potato.
